(19) United States
(12) Patent Application Publication
(10) Pub. No.: US 2018/0139950 A1
(43) Pub. Date: May 24, 2018

(54) Line Electric Fence Light Gas Discharge Lamps

(71) Applicant: John C. Bishop, Cookeville, TN (US)

(72) Inventor: John C. Bishop, Cookeville, TN (US)

(21) Appl. No.: 15/822,089

(22) Filed: Nov. 24, 2017

Related U.S. Application Data
(60) Provisional application No. 62/425,662, filed on Nov. 23, 2016.

(51) Int. Cl. A01M 29/10; H01J 61/06; H01J 61/30; H05C 1/04; E04H 17/06; A01K 3/00

(52) U.S. Cl. CPC A01M 29/10; H01J 61/06; A01K 3/005; H05C 1/04; E04H 17/06; H01J 61/30

(57) ABSTRACT

A series (e.g., string) of flashing lights can temporarily blind animals that view the lights within about 25 feet of the lights, deterring them from even approaching the series of flashing lights. The series of flashing lights is placed about the perimeter of an area to be protected. In one embodiment, the flashing lights are gas discharge bulbs connected in series and driven by an electric fence charger.

### CROSS-REFERENCES TO RELATED APPLICATIONS

This application claims priority to and hereby incorporates by reference in its entirety U.S. Provisional Patent Application No. 62/425,662 entitled “IN LINE ELECTRIC FENCE LIGHT GAS DISCHARGE LAMPS” filed on Nov. 23, 2016.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to systems and methods for protecting crops, livestock, and food storage. More particularly, this invention pertains to systems for deterring the presence of pests and predators in protected areas.

Current methods of deterring rodents, pests, and predators from an area include trapping, poisoning, using electric fences, emitting high pitched sounds, and “predator lights” (i.e., devices that generate a single, small red light to mimic an eye of a predator at night). Trapping rodents, pests, and predators to remove them from a protected area is very inefficient to the point that it is often only marginally effective. Poison baits affect animals other than the target animals, can be carried beyond the protected area by poisoned animals, and can cause undesired effects in the local ecosystem as the poisons work their way through the food chain. Electric fences are effective for moderately sized animals, but they must be kept clear of brush to be effective, deer often jump over the fences, hogs and rodents go under the fence, and bears and other wild animals (e.g., elk and moose) often walk through the fences and destroy them because they are unfamiliar with electric fences. Devices that emit high pitch or high frequency sounds (typically supersonic to humans) are generally effective but have a limited effective range and become less effective when buried in snow, during storms, and during other conditions that may reduce sound dispersion from the source device. Additionally, users are frequently only alerted to a problem with a high frequency sound generator when they realize that the sound generator is no longer effective. “Predator lights” or single red light generators emit a faint red light that mimics an eye of a large predator. They typically have a 90 degree viewing cone which means that only one side of a building can be protected with one light, and because the lights are small and dim, if an object (e.g., a tree) blocks direct viewing of the light, a path for a rodent or smaller predator to approach the protected area is provided, rendering the light ineffective. Additionally, larger predators (e.g., bears) may not be deterred by a “predator light”.

### BRIEF SUMMARY OF THE INVENTION

Aspects of the present invention provide a series (e.g., string) of flashing lights that will temporarily blind animals that view the lights within about 25 feet of the lights, deterring them from even approaching the series of flashing lights.

In one aspect of the invention, a system for deterring predators and pests from a protected area includes a plurality of light sources and a plurality of fence sections. The plurality of light sources are connected in series by the plurality of fence sections.

In another aspect of the invention, a method of deterring predators and pests from a protected area is disclosed. The method includes connecting a plurality of light sources in series via a plurality of fence sections. The plurality of fence sections and series connected light sources are positioned about the area to be protected (i.e., protected area).

### BRIEF DESCRIPTION OF THE SEVERAL VIEWS OF THE DRAWINGS

FIG. 1 is a block and partial schematic diagram of an electric fence monitor including a gas discharge lamp and wire coil.

FIG. 2 is a schematic diagram of a gas discharge lamp in a series of gas discharge lamps.

FIG. 3 is a block diagram of a series of gas discharge lamps configured to deter pests from a protected area.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. As described herein, a plurality of series connected light sources includes a first light source, electrically near (e.g., directly connected to) a charging source (e.g., an electric fence charger), one or more next or subsequent light sources in the series, and a last or final light source in the series which is connected to a ground (e.g., an earth grounding spike).

As used herein, “ballast” and “driver circuit” refer to any circuit for providing power (e.g., current) from a power source to a light source. Additionally, “light source” refers to one or more light emitting devices such as fluorescent lamps, high intensity discharge lamps, incandescent bulbs, and solid state light-emitting elements such as light emitting diodes (LEDs), organic light emitting diodes (OLEDs), and plasmaloids. Further, “connected between” or “connected to” means electrically connected when referring to electrical devices in circuit schematics or diagrams. The electrical connection may be direct or indirect (i.e., connected via one or more other elements).

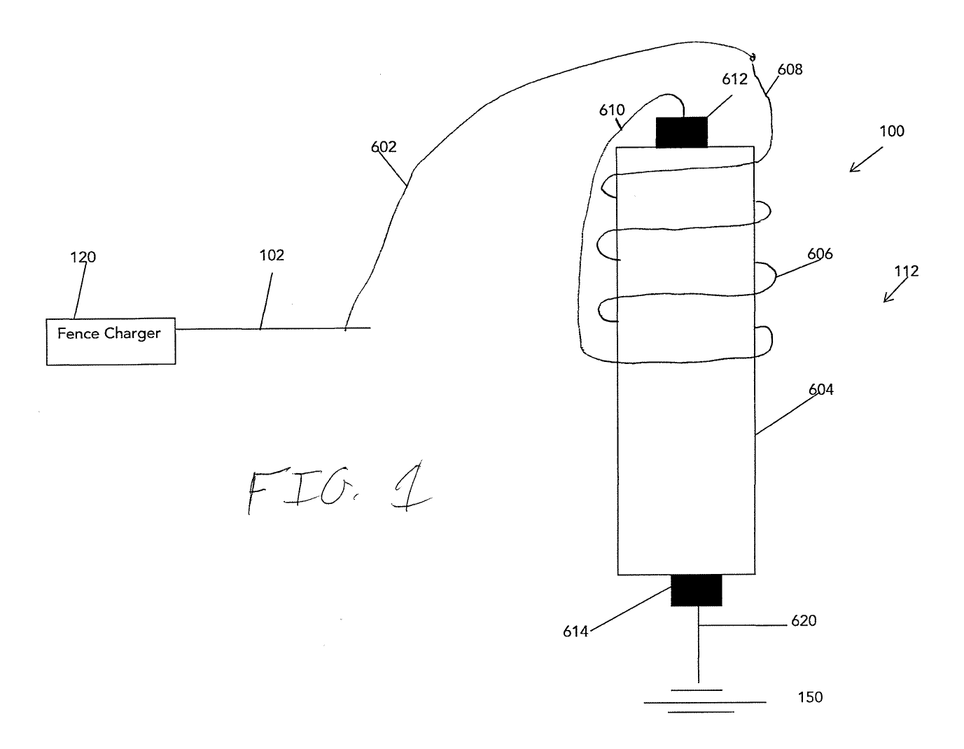

Referring to FIGS. 1-3, a system 100 for deterring predators and pests from a protected area 103 is shown. The electric fence 102 is periodically energized or charged by the electric fence charger 120 (i.e., electric fence box). The system 100 includes a plurality of light sources 112 connected in series and each configured to provide light in response to receiving power. Each light source 112 includes a wire coil 606.

Referring to FIG. 1, in one embodiment, the light source 112 is a gas discharge lamp including a substantially transparent tube 604, a first electrode 612, and a second electrode 614. The tube 604 is substantially transparent and has a first end and a second end opposite the first end. The first electrode 612 is at the first end of the tube 604. The second electrode 614 is at the second end of the tube 604, and the second electrode 614 is configured to connect to the earth ground 150 via a ground lead 620. The second electrode 614 may be connected to the earth ground 150 via the ground lead 620 and additional light sources 112 connected in series with the light source. The wire coil 606 is wound about the tube 604 of the gas discharge lamp from the first electrode 612 (e.g., the first end of the tube 604) toward the second electrode 614 (e.g., the second end of the tube 604). The wire coil 606 has a first end 608, and a second end 610. The first end 608 of the wire coil 606 is configured to connect to the electric fence 102. A length of electric fence 102 separates the fence charger at 120 from the first end 608 of the wire coil 606.

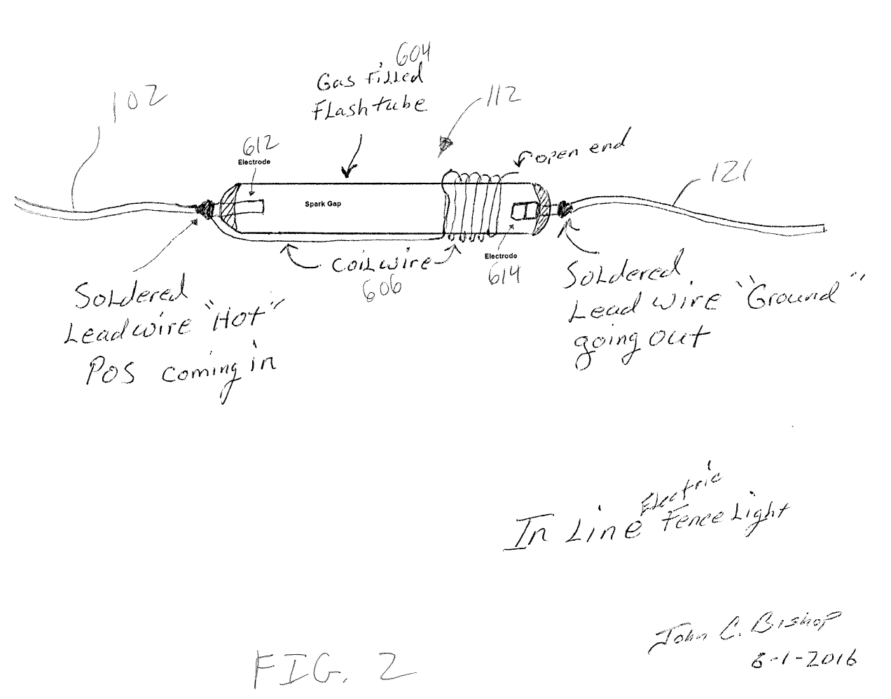

Referring to FIG. 2, a second embodiment of the light source 112 is shown. The light source 112 is similar to the light source 112 shown in FIG. 1 except that the coil 606 is wound about the tube 604 from the first electrode 612 toward the second electrode 614, and located at the second end of the tube 604 adjacent the second electrode 614.

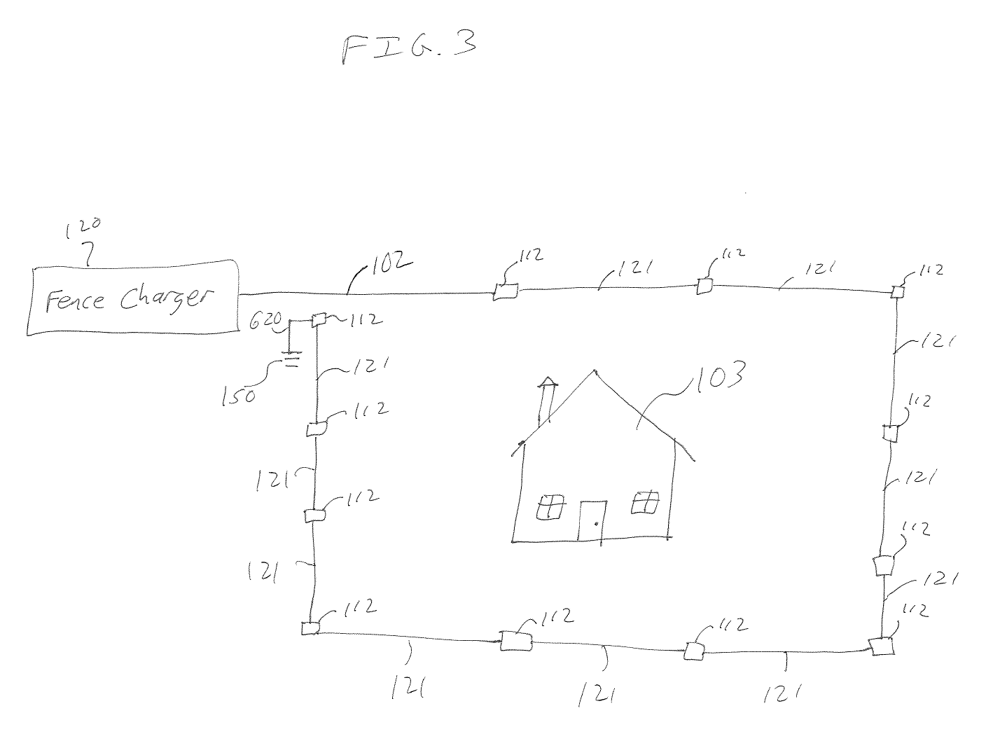

Referring to FIG. 3, a system 100 for deterring predators and pests from a protected area 103 is shown. A fence charger 120 (e.g., electric fence box) periodically energizes a section of electric fence 102. A light source 112 is connected to the section of fence 102. Additional sections of fence 121 (i.e., fence sections) connect additional light sources 112 in series between the section of fence 102 and the ground lead 620. The ground lead 620 connects the final or last light source 112 in the series to earth ground 150 (e.g., an earth grounding spike). As the fence charger 120 periodically energizes the fence and light sources, the light sources 112 emit bursts of light that blind and deter pests and predators. In one embodiment, the sections of fence 102, 121 are electrically insulated. Additionally, the wire coil 606 may be encapsulated about the gas tube 604 and/or affixed to the gas tube 604 such as by an adhesive. In one embodiment, the wire coil 606 is exposed (i.e., not covered) by an encapsulating material or electrically non-conductive material. In one embodiment, the plurality of light sources 112 and fence sections 102, 121 substantially enclose or encircle the area to be protected such that the plurality of fence sections 102, 121 and light sources 112 connected in series define a perimeter of the area to be protected by the system 100.

In one embodiment, the tube 604 of the gas discharge lamp is substantially filled with xenon gas. That is, the gas inside the tube 604 is at least 90% xenon and preferably, approximately 100% xenon. Xenon gas has a capacitive type charge carrying capability similar to an air gap such that the power on the electric fence is not drawn down or dissipated by any single light source 112 in the series. In one embodiment, current draw from the fence 102 by each light source 112 in the series of light sources is further adjusted by altering the distance that the wire coil 606 extends along the tube 604 of the gas discharge lamp or by altering the number of turns in the wire coil 606 about the tube 604 of the gas discharge lamp. That is, altering the extension and/or turns of the wire coil 606 alters the ionization of the gases inside the tube 604, changing the impulse response of the overall electric fence monitor 100. Increasing the extension of the wire coil 606 along the tube 604 and increasing the number of turns of the wire coil 606 about the tube 604 both increase the current draw of the electric fence monitor 100. Current draw can thus be manually adjusted (e.g., minimized) after installation of the electric fence monitor 100 on site if the coil 606 is not affixed to or encapsulated about the tube 604. Generally, the current draw (e.g., ionization) would be reduced until the gas discharge lamp (i.e., light source 112) does not reliably emit a flash of light, and then the current draw (e.g., ionization) would be increased slightly to ensure flashing of the light source 112 in response to the fence charger 120 periodically charging the fence 102.

In one embodiment, the tube 604 of the gas discharge lamp is filled with a mixture including at least 75% xenon and preferably at least 15% argon. In one embodiment, the tube 604 is filled with a mixture of gas including approximately 75% xenon and 25% argon. Argon gas and other noble gases have a slightly different impulse response then xenon gas (i.e., a response more closely resembling a constant resistance that can draw down the static charge on the electric fence 102).

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful IN LINE ELECTRIC FENCE LIGHT GAS DISCHARGE LAMPS it is not intended that such references be construed as limitations upon the scope of this invention except as set forth in the following claims.

What is claimed is:

1. A system for deterring predators and pests from a protected area, said system comprising:
a plurality of light sources connected in series by a plurality of fence sections.

2. The system of claim 1 further comprising:
a fence charger connected to a first light source of the plurality of light sources connected in series.

3. The system of claim 1 further comprising:
an electric fence box connected to a first light source of the plurality of light sources connected in series.

4. The system of claim 1 further comprising:
a fence charger connected to a first light source of the plurality of light sources connected in series, wherein the first light source is the first light source of the plurality of series connected light sources; and
a ground spike connected to a last light source of the plurality of light sources connected in series, wherein the last light source is the last light source in the plurality of light sources connected in series.

5. The system of claim 1 further comprising:
an electric fence box connected to a first light source of the plurality of light sources connected in series, wherein the first light source is the first light source of the plurality of series connected light sources; and
a ground spike connected to a last light source of the plurality of light sources connected in series, wherein the last light source is the last light source in the plurality of light sources connected in series.

6. The system of claim 1, further comprising:
an electric fence charger connected to a first fence section of the plurality of fence sections, wherein:
a last fence section of the plurality of fence sections is connected to an earth ground spike; and
the plurality of fence sections and light sources substantially encircle the protected area.

7. The system of claim 1, wherein:
each light source of the plurality of light sources is a gas discharge lamp, and each gas discharge lamp comprises:
a substantially transparent tube having a first end and a second end opposite the first end;
a first electrode at the first end of the tube; and
a second electrode at the second end of the tube, wherein the second electrode is configured to connect to an earth ground; and
a wire coil wound about the tube of the gas discharge lamp, wherein the wire coil is connected to the first electrode.

8. The system of claim 1, wherein:
each light source of the plurality of light sources is a gas discharge lamp, and each gas discharge lamp comprises:
a substantially transparent tube having a first end and a second end opposite the first end;
a first electrode at the first end of the tube; and
a second electrode at the second end of the tube, wherein the second electrode is configured to connect to an earth ground; and
a wire coil wound about the tube of the gas discharge lamp, wherein the wire coil is connected to the first electrode and wound from the first end of the tube toward the second end of the tube and located at the second end of the tube.

9. The system of claim 1, wherein:
each light source of the plurality of light sources is a gas discharge lamp, and each gas discharge lamp comprises:
a substantially transparent tube having a first end and a second end opposite the first end;
a first electrode at the first end of the tube; and
a second electrode at the second end of the tube, wherein the second electrode is configured to connect to an earth ground; and
a wire coil wound about the tube of the gas discharge lamp, wherein the wire coil is connected to the first electrode, wherein the wire coil is wound from the first end of the tube toward the second end of the tube.

10. The system of claim 1, wherein:
each light source of the plurality of light sources is a gas discharge lamp, and each gas discharge lamp comprises:
a substantially transparent tube having a first end and a second end opposite the first end;
a first electrode at the first end of the tube; and
a second electrode at the second end of the tube, wherein the second electrode is configured to connect to an earth ground; and
a wire coil wound about the tube of the gas discharge lamp, wherein the wire coil is connected to the first electrode, wherein the second electrode of each gas discharge lamp is connected to the wire coil of a next gas discharge lamp in the plurality of series connected gas discharge lamps.

11. The system of claim 1, wherein:
each light source is a gas discharge bulb: and
each gas discharge bulb is filled with a at least 90% Xenon, or 85% Xenon and 15% Argon.

12. A method of deterring predators and pests from a protected area, said method comprising:
connecting a plurality of light sources in series via a plurality of fence sections.

13. The method of claim 12, further comprising:
connecting a fence charger to a first light source of the plurality of light sources connected in series.

14. The method of claim 12, further comprising:
connecting an electric fence box to a first light source of the plurality of light sources connected in series.

15. The method of claim 12, further comprising:
connecting a fence charger to a first light source of the plurality of light sources connected in series, wherein the first light source is the first light source of the plurality of series connected light sources; and
connecting a ground spike to a last light source of the plurality of light sources connected in series, wherein the last light source is the last light source in the plurality of light sources connected in series.

16. The method of claim 12, further comprising:
connecting an electric fence box to a first light source of the plurality of light sources connected in series, wherein the first light source is the first light source of the plurality of series connected light sources; and
connecting a ground spike to a last light source of the plurality of light sources connected in series, wherein the last light source is the last light source in the plurality of light sources connected in series.

17. The method of claim 12, further comprising:
connecting an electric fence charger to a first fence section of the plurality of fence sections, wherein:
connecting a last fence section of the plurality of fence sections to an earth ground spike; and
substantially enclosing the protected area with the plurality of fence sections and gas discharge lamps or placing the plurality of light sources and fence sections connected in series about a perimeter of an area to be protected.

18. The method of claim 12, wherein:
each light source of the plurality of light sources is a gas discharge lamp, and each gas discharge lamp comprises:
a substantially transparent tube having a first end and a second end opposite the first end;
a first electrode at the first end of the tube; and
a second electrode at the second end of the tube, wherein the second electrode is configured to connect to an earth ground; and
a wire coil wound about the tube of the gas discharge lamp, wherein the wire coil is connected to the first electrode.

19. The method of claim 12, wherein:
each light source of the plurality of light sources is a gas discharge lamp, and each gas discharge lamp comprises:
a substantially transparent tube having a first end and a second end opposite the first end;
a first electrode at the first end of the tube; and
a second electrode at the second end of the tube, wherein the second electrode is configured to connect to an earth ground; and
a wire coil wound about the tube of the gas discharge lamp, wherein the wire coil is connected to the first electrode and wound from the first end of the tube toward the second end of the tube and located at the second end of the tube.

20. The method of claim 12, wherein:
each light source of the plurality of light sources is a gas discharge lamp, and each gas discharge lamp comprises:
a substantially transparent tube having a first end and a second end opposite the first end;
a first electrode at the first end of the tube; and
a second electrode at the second end of the tube, wherein the second electrode is configured to connect to an earth ground; and
a wire coil wound about the tube of the gas discharge lamp, wherein the wire coil is connected to the first electrode, wherein the wire coil is wound from the first end of the tube toward the second end of the tube.
